(19) United States
(12) Patent Application Publication
(10) Pub. No.: US 2026/0009498 A1
(43) Pub. Date: Jan. 8, 2026

(54) FOLDABLE STAND

(71) Applicant: ONED CO., LTD., Ji'an Township (TW)

(72) Inventor: Chih Ju Kuo, Ji'an Township (TW)

(21) Appl. No.: 19/253,500

(22) Filed: Jun. 27, 2025

(30) Foreign Application Priority Data
Jul. 3, 2024 (TW) 113207109

(51) Int. Cl. F16M 11/38; F16M 11/10

(52) U.S. Cl. CPC F16M 11/38; F16M 11/10; F16M 2200/021

(57) ABSTRACT

A foldable stand has a base and a bracket mechanism. The base has a structural surface that is recessed inward to form an accommodating space. The bracket mechanism can be folded to be accommodated in the accommodating space. The bracket mechanism is selectively in an unfolded state or a folded state. The bracket mechanism includes a first bracket, a second bracket, a support member, and at least one restricting rod. The first bracket, the second bracket and the support member are pivotally connected to one another in sequence, and the first bracket is pivotally connected to the structural surface of the base. An engaging member is connected at a pivot position of the first bracket and the second bracket for controlling the second bracket to be unfolded and secured or to be folded. The restricting rod is pivotally connected between the second bracket and the structural surface of the base for restricting a pivot angle of the first bracket relative to the base.

This application claims the priority benefit of Taiwan patent application number 113207109 filed on July 3, 2024.

### FIELD OF THE INVENTION

The present invention relates to a foldable stand, and more particularly, to a foldable stand which can be folded with ease, has better support strength and is small in size after being folded.

### BACKGROUND OF THE INVENTION

Mobile phones and tablet computers need to be held in the hands to browse information and watch videos. However, holding mobile phones/tablet computers for a long time will cause hand pain and discomfort. Therefore, there are various stands for holding mobile phones/tablet computers on the markets, allowing users to free their hands.

Taiwan Utility Model Publication No. M643109 discloses a foldable stand, which is a platy multi-layer structure that can be unfolded to hold a mobile phone. However, the support height is not enough. Users need to lower their heads to use mobile phones/tablet computers, which may cause neck pain after long-term use. Taiwan Utility Model Publication No. M628756 discloses a mobile device stand. Although the mobile device can be supported at a higher position, multiple components need to be manually operated to unfold or fold the stand, resulting in poor ease of use.

### SUMMARY OF THE INVENTION

The primary object of the present invention is to provide a foldable stand having a bracket mechanism that can be unfolded or folded relative to a base. The bracket mechanism includes a first bracket, a second bracket and a support member that can be pivoted and folded relative to each other. When the first bracket and the second bracket are unfolded, the second bracket is secured in place relative to the first bracket by an engaging member, in cooperation with restricting rods to restrict a pivot angle of the first bracket relative to a base, such that the first bracket and the base form a stable support structure. Thus, the foldable stand has a suitable support height after being unfolded. When the engaging member releases the second bracket, the bracket mechanism can be folded. The folding and unfolding operations are simple. After being folded, the foldable stand is in the form of a platy structure, occupying less space.

In order to achieve the foregoing object, the present invention provides a foldable stand. The foldable stand has a base. The base has a structural surface and a support surface opposite to the structural surface. The structural surface is recessed inward to form an accommodating space. A bracket mechanism that is foldable to be accommodated in the accommodating space is pivotally connected to the structural surface. The bracket mechanism is selectively in an unfolded state or a folded state. The bracket mechanism comprises a first bracket, a second bracket, at least one restricting rod, and a support member.

The first bracket has one end pivotally connected to the structural surface of the base.

The second bracket has one end pivotally connected to another end of the first bracket. An engaging member is connected at a pivot position of the first bracket and the second bracket for controlling the second bracket to be unfolded and secured in place relative to the first bracket or to be folded.

The restricting rod is pivotally connected between the second bracket and the structural surface of the base for restricting a pivot angle of the first bracket relative to the base.

The support member is pivotally connected to another end of the second bracket for connecting a supported object.

When the bracket mechanism is in the folded state, the first bracket and the second bracket are relatively pivoted and folded together with the support member and accommodated in the accommodating space to form a platy structure. When the bracket mechanism is in the unfolded state, the first bracket and the second bracket are pivoted and unfolded in opposite directions until the second bracket is secured in place relative to the first bracket by the engaging member, and the restricting rod restricts the pivot angle of the first bracket relative to the base, such that the first bracket and the second bracket are unfolded upward.

Embodiments of the present invention will now be described, by way of example only, with reference to the accompanying drawings.

### BRIEF DESCRIPTION OF THE DRAWINGS

FIG. 1 is a perspective view of the present invention in a folded state;

FIG. 2 is a perspective view of the present invention in an unfolded state;

FIG. 3 is a schematic side view of the present invention, illustrating that the foldable stand is unfolded from the folded state;

FIG. 4 is a schematic side view of the present invention in the unfolded state;

FIG. 5 is a perspective view of the present invention when in use;

FIG. 6 is another perspective view of the present invention when in use; and

FIG. 7 is a further perspective view of the present invention when in use.

### DETAILED DESCRIPTION OF THE PREFERRED EMBODIMENTS

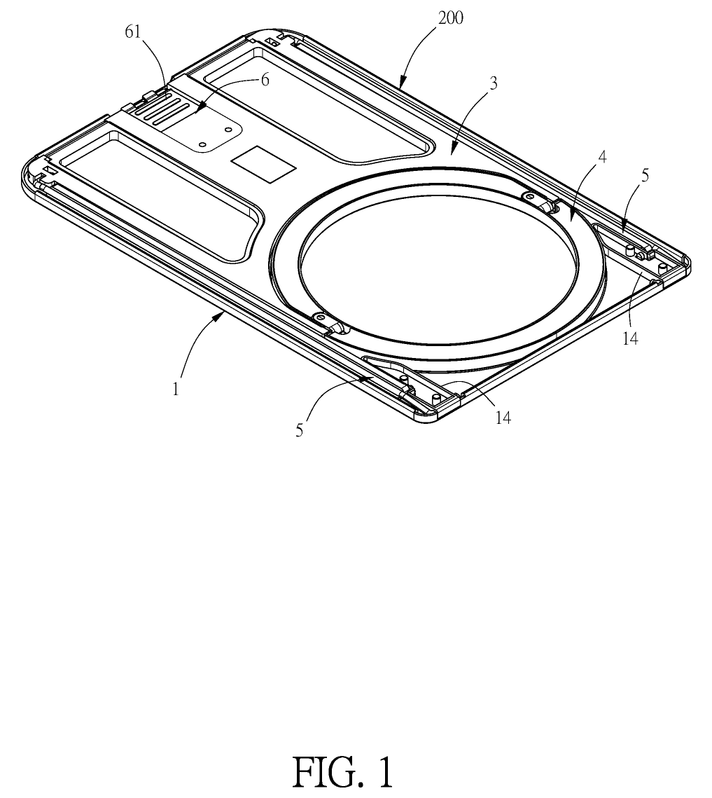

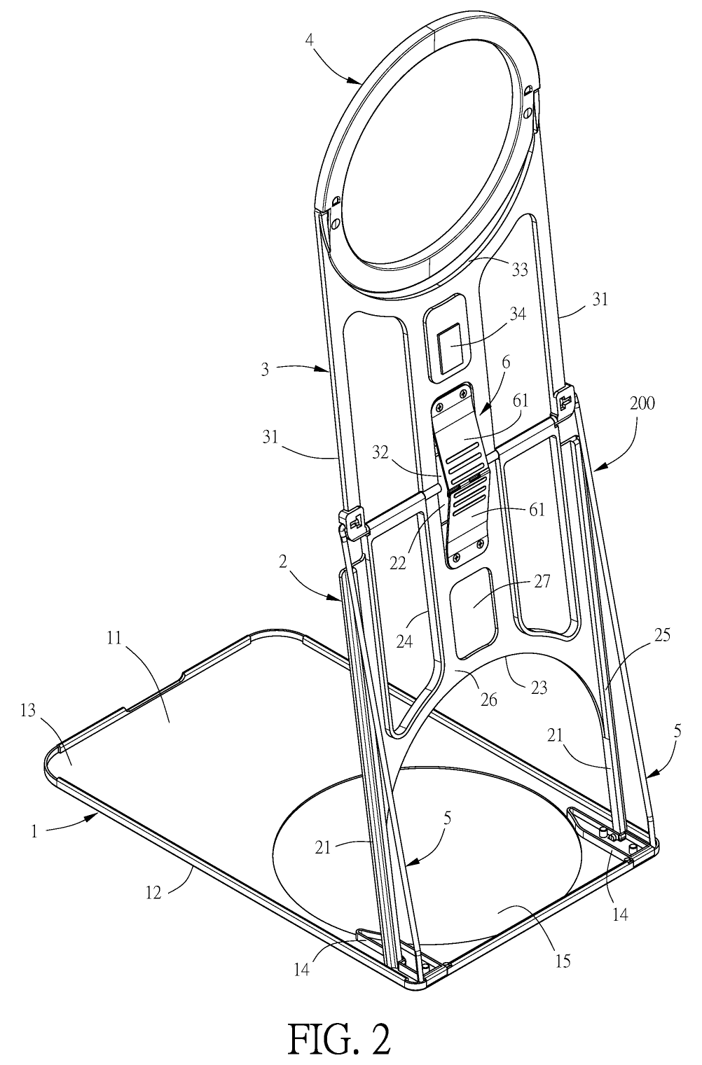

The present invention discloses a foldable stand. As shown in FIG. 1 and FIG. 2, the foldable stand provided by the present invention has a base 1. The base 1 has a structural surface 11 and a support surface 12 opposite to the structural surface 11. The structural surface 11 is recessed inward to form an accommodating space 13. A bracket mechanism 200 is pivotally connected to the structural surface 11, and the bracket mechanism 200 can be pivoted to be accommodated in the accommodating space 13. The bracket mechanism 200 is selectively in an unfolded state or a folded state.

Specifically, two pivot seats 14 are symmetrically provided on one side of the structural surface 11 of the base 1. The bracket mechanism 200 includes a first bracket 2, a second bracket 3, a support member 4, and at least one restricting rod 5. The first bracket 2 is pivotally connected to the two pivot seats 14 through two first support legs 21 that are arranged symmetrically, so that the first bracket 2 can be pivoted relative to the base I with the two pivot seats 14 as pivot points. The second bracket 3 is pivotally connected to one end of the first bracket 2, opposite to the first support legs 21, through two second support legs 31 that are arranged symmetrically, so that the second bracket 3 can be pivoted relative to the first bracket 2. Because the base 1, the first bracket 2 and the second bracket 3 are pivotally connected to one another, the first bracket 2 and the second bracket 3 can be pivoted relative to each other for unfolding or folding.

An engaging member 6 is connected at the pivot position of the first bracket 2 and the second bracket 3. The engaging member 6 includes two elastic sheets 61 that are engageable with each other. The first bracket 2 and the second bracket 3 have a first groove 22 and a second groove 32 at the pivot position. The two elastic sheets 61 are mounted in the first groove 22 and the second groove 32, respectively. When the bracket mechanism 200 is to be unfolded, the first bracket 2 and the second bracket 3 are pivoted in opposite directions until the first groove 22 and the second groove 32 face each other. At this time, the two elastic sheets 61 are engaged with each other to secure the second bracket 3 in place. When the bracket mechanism 200 is to be folded, the two elastic sheets 61 are pressed to release the second bracket 3.

Furthermore, the restricting rod 5 is pivotally connected to either side of the second bracket 3, or the restricting rod 5 is pivotally connected to only one side of the second bracket 3. The other end of the restricting rod 5 is pivotally connected to one end of the corresponding pivot seat 14 close to the edge of the structural surface 11. When the bracket mechanism 200 is in the unfolded state, the second bracket 3 is secured by the engaging member 6 so that it cannot pivot relative to the first bracket 2. Since the restricting rod 5 connects the second bracket 3 in the unfolded state with the pivot seat 14, the first bracket 2 is restricted from pivoting toward the structural surface 11 of the base 1. The present invention is simple in structure and easy to operate by means of the engagement of the engaging member 6 and the restriction of the restricting rod 5 to secure the first bracket 2 and the second bracket 3 in place after they are unfolded.

In addition, the base 1 defines a through hole 15 passing through the structural surface 1l and the support surface 12. One end of the first bracket 2, pivoted to the structural surface 11, has a first arc-shaped edge 23. One end of the second bracket 3, pivoted to the support member 4, has a second arc-shaped edge 33. The support member 4 is circular. The center of the support member 4 overlaps with the arc center of the second arc-shaped edge 33. The radius of the support member 4 is smaller than the radius of the second arc-shaped edge 33, so that the support member 4 can be pivoted to be on the same horizontal plane as the second arc-shaped edge 33. The first bracket 2 has a contact surface 24 and a receiving surface 25 opposite to the contact surface 24. The receiving surface 25 is formed with a receiving trough 26 for receiving the second bracket 3. One surface of the second bracket 3, which can be attached to the receiving surface 25, has a magnet 34. The first bracket 2 has a magnetic hole 27 for the magnet 34 to pass through. When the support mechanism 200 is in the folded state, the contact surface 24 of the first bracket 2 is in contact with the structural surface l l of the base 1, the second bracket 3 is received in the receiving trough 26, and the second arc-shaped edge 33 overlaps with the first arc-shaped edge 23 and fits on the edge of the through hole 15. At this time, the support member 4 is pivoted to be on the same horizontal plane as the second arc-shaped edge 33, such that the support member 4 can be placed in the through hole 15. The magnet 34 passes through the magnetic hole 27 and is magnetically attracted to the base 1, preventing the second bracket 3 from detaching in the folded state. After being folded, the first bracket 2, the second bracket 3 and the support member 4 are integrated with the base 1 to form a platy structure, thereby saving storage space.

The support member 4 has a magnetic element that can be magnetically attracted to a connecting member 7 made of a metal material. In this embodiment, the magnetic element is a

magnet. The connecting member 7 is attached to a supported object 8, allowing the supported object 8 to rotate about the support member 4

In other possible implementations, the support member 4 is mounted on the supported object 8, and the support member 4 is detachably pivoted to the second bracket 3, so that the supported object 8 can be selectively pivoted to the second bracket 3 according to use needs.

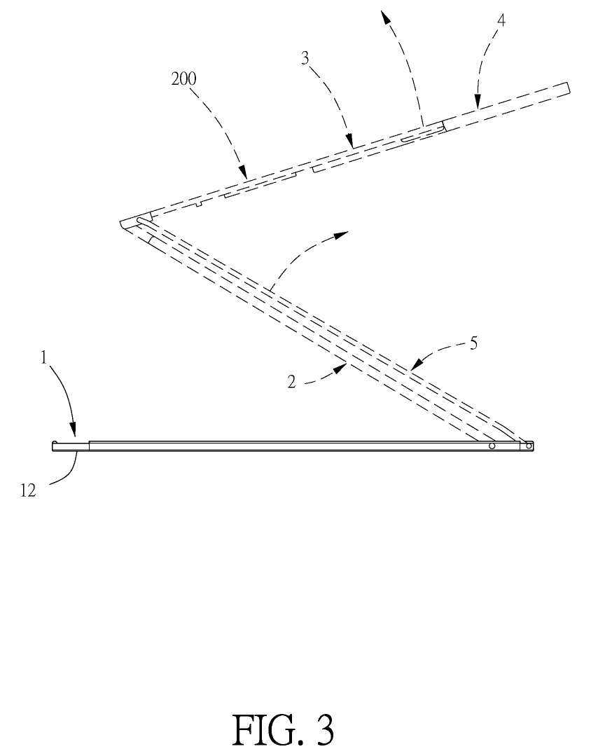

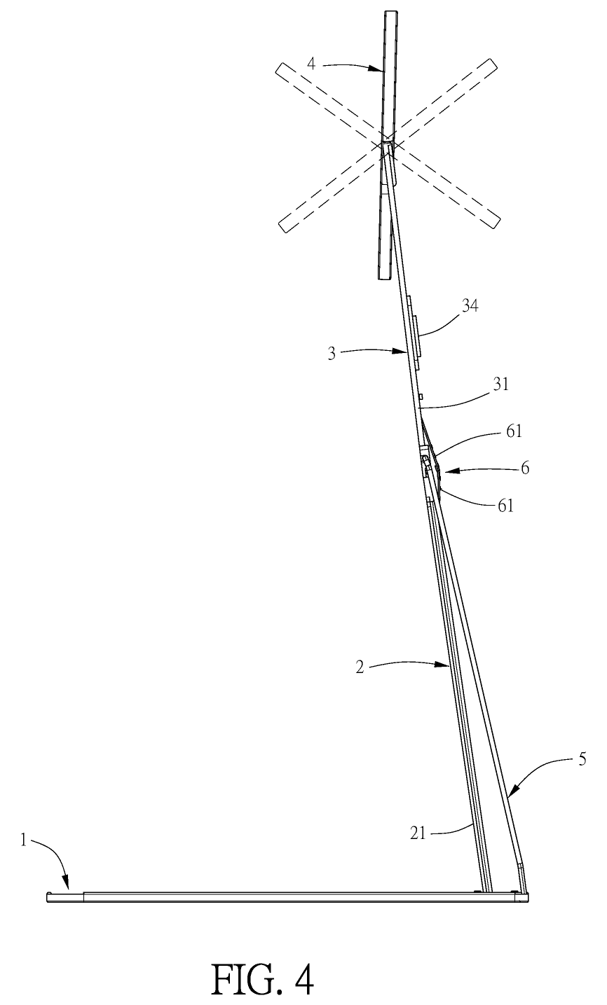

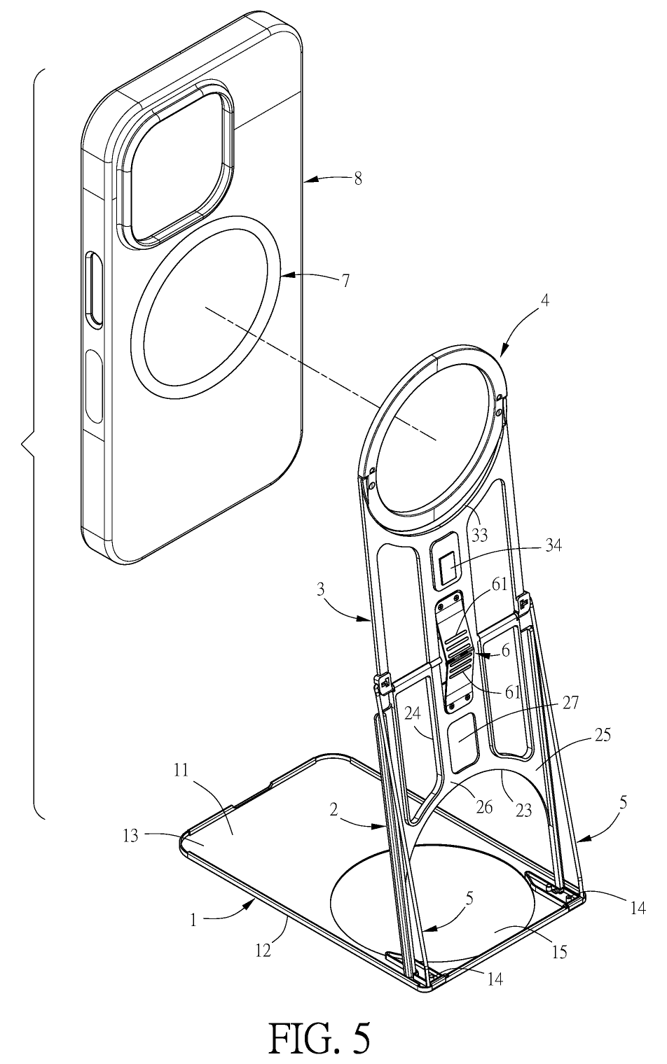

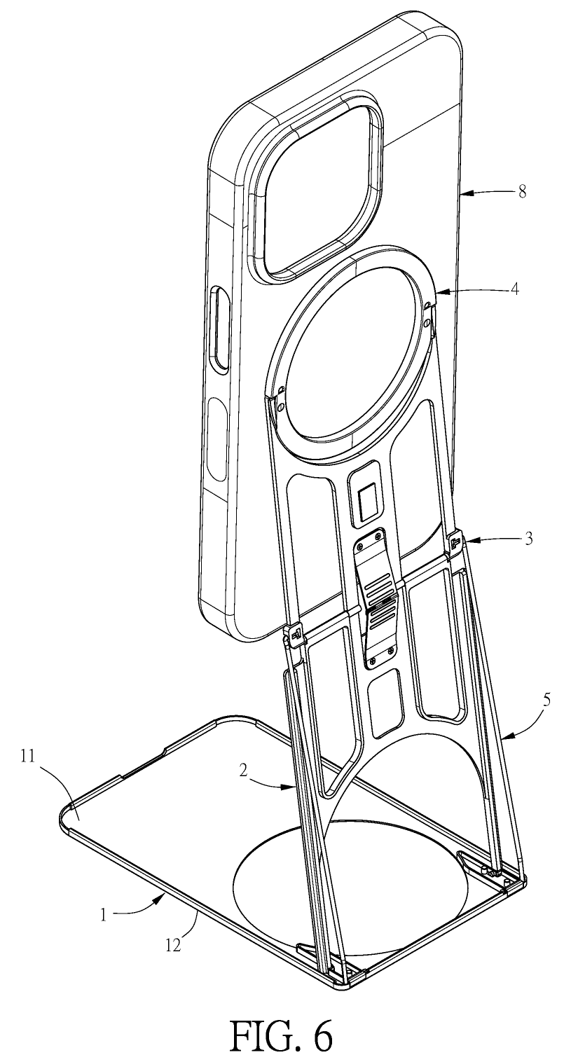

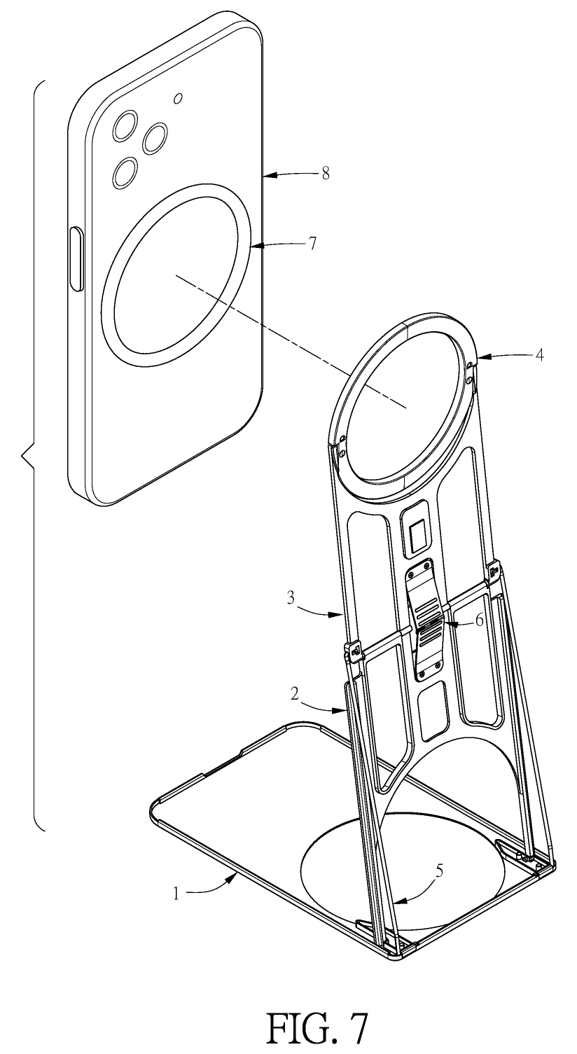

When in use, as shown in FIG. 3 and FIG. 4, the bracket mechanism 200 in the folded state is first pulled away from the base 1, and the support member 4 is pulled upward to drive the first bracket 2 and the second bracket 3 to pivot in opposite directions. When the first groove 22 of the first bracket 2 and the second groove 32 of the second bracket 3 face each other, the two elastic sheets 61 of the engaging member 6 engage with each other to secure the second bracket 3 and the first bracket 2 in place, and the restricting rods 5 pull the second bracket 3 to restrict the pivot angle of the first bracket 2 relative to the base 1. At this time, the bracket mechanism 200 is fully unfolded. The restricting rods 5, the first bracket 2 and the base I form a triangular support structure, which improves the stability of the overall structure after being unfolded. As shown in FIG. 5 and FIG. 6, the connecting member 7 such as an iron sheet is mounted on a supported object 8. The supported object 8 may be a mobile phone, a tablet computer or a protective case thereof. In this embodiment, the connecting member 7 is mounted on the back of a mobile phone protective case. As shown in FIG. 7, the connecting member 7 is mounted on a mobile phone. The support surface 12 of the base 1 is placed on an object surface. Then, the supported object 8 with the connecting member 7 mounted thereon is attracted and attached to the support member 4, and the support member 4 is adjusted to an angle suitable for using the mobile phone or tablet computer. The user can rotate the supported object 8 to different angles according to the needs, and then the supported object 8 is attached to the support member 4. Alternatively, the supported object 8 is first attached to the support member 4, and then the supported object 8 is rotated to a desired angle.

After use, the two elastic sheets 61 of the engaging member 6 are disengaged from each other to release the second bracket 3. Under the action of their own weight, the first bracket 2 and the second bracket 3 are pivoted and folded in opposite directions, so that the first bracket 2 is in contact with the structural surface II of the base I, the second bracket 3 is received in the receiving trough 26 of the first bracket 2, and the support member 4 is pivoted to be on the same horizontal plane as the second arc-shaped edge 33 of the second bracket 3 and is received in the through hole 15 of the base 1. Finally, the foldable stand is folded to form a platy structure that fits the back of the supported object 8, which does not affect the overall aesthetics of the supported object 8 and is compact and easy to carry.

The foldable stand provided by the present invention has the following effects and advantages:

1. Simple structure, easy to operate. The structure of the present invention mainly consists of the base, the first bracket, the second bracket, and the support member, with fewer components and a simple structure. The first bracket, the second bracket and the support member are pivotally connected to one another. The engaging member composed of the two elastic sheets is connected at the pivot position of the first bracket and the second bracket. The engaging member is configured for controlling and securing the second bracket in place, in cooperation with the restricting rods to restrict the pivot angle of the first bracket, such that the foldable stand can be unfolded stably. When the engaging member releases the second bracket, the bracket mechanism can be folded and accommodated in the accommodating space of the base. When in use, there is no need to operate multiple components. It is simple and easy to operate the foldable stand.

2. Small size, easy to store. After the foldable stand provided by the present invention is folded, the first bracket, the second bracket and the support member can be stacked together to become one-piece, which can be stored in the accommodating space of the base, forming a platy structure that is small in size and easy to store.

3. Flexible application. The support member of the present invention is a magnetic element such as a magnet. The connecting member made of a metal material can be magnetically attracted to the magnetic element, so it can be rotated relative to the support member, thereby allowing the supported object to be rotated at different angles according to the needs.

What is claimed is:

1. A foldable stand, having a base, the base having a structural surface and a support surface opposite to the structural surface, the structural surface being recessed inward to form an accommodating space, a bracket mechanism that is foldable to be accommodated in the accommodating space being pivotally connected to the structural surface, the bracket mechanism being selectively in an unfolded state or a folded state, the bracket mechanism comprising:
a first bracket, having one end pivotally connected to the structural surface of the base;
a second bracket, having one end pivotally connected to another end of the first bracket, an engaging member being connected at a pivot position of the first bracket and the second bracket for controlling the second bracket to be unfolded and secured in place relative to the first bracket or to be folded;
at least one restricting rod, pivotally connected between the second bracket and the structural surface of the base for restricting a pivot angle of the first bracket relative to the base;
a support member, pivotally connected to another end of the second bracket for connecting a supported object;
wherein when the bracket mechanism is in the folded state, the first bracket and the second bracket are relatively pivoted and folded together with the support member and accommodated in the accommodating space to form a platy structure; when the bracket mechanism is in the unfolded state, the first bracket and the second bracket are pivoted and unfolded in opposite directions until the second bracket is secured in place relative to the first bracket by the engaging member, and the restricting rod restricts the pivot angle of the first bracket relative to the base, such that the first bracket and the second bracket are unfolded upward.

2. The foldable stand as claimed in claim 1, wherein two pivot seats are symmetrically provided on one side of the structural surface of the base, the first bracket has two first support legs that are arranged symmetrically, and the two first support legs are pivotally connected to the two pivot seats so that the first bracket can be pivoted relative to the base with the two pivot seats as pivot points.

3. The foldable stand as claimed in claim 2, wherein the second bracket has two second support legs that are arranged symmetrically, and the two second support legs are pivotally connected to the end of the first bracket, opposite to the first support legs, so that the second bracket can be pivoted relative to the first bracket.

4. The foldable stand as claimed in claim 2, wherein the restricting rod is pivotally connected to either side of the second bracket, and the restricting rod has one end pivotally connected to one end of the corresponding pivot seat close to an edge of the structural surface for restricting the pivot angle of the first bracket.

5. The foldable stand as claimed in claim 1, wherein the first bracket and the second bracket have a first groove and a second groove at the pivot position, the engaging member includes two elastic sheets that are engageable with each other, the two elastic sheets are mounted in the first groove and the second groove, when the bracket mechanism is in the unfolded state, the first bracket and the second bracket are pivoted until the first groove and the second groove face each other, and the two elastic sheets are engaged with each other to secure the second bracket in place; when the bracket mechanism is in the folded state, the two elastic sheets are pressed to release the second bracket.

6. The foldable stand as claimed in claim 1, wherein the first bracket has a contact surface and a receiving surface opposite to the contact surface, the receiving surface is formed with a receiving trough for receiving the second bracket, when the bracket mechanism is in the folded state, the contact surface of the first bracket is in contact with the structural surface of the base, and the second bracket is received in the receiving trough.

7. The foldable stand as claimed in claim 6, wherein a magnet is provided on one surface of the second bracket, the first bracket has a magnetic hole for the magnet to pass through, when the bracket mechanism is in the folded state, the magnet passes through the magnetic hole and is magnetically attracted to the base.

8. The foldable stand as claimed in claim 6, wherein the support member is circular, the end of the second bracket, pivoted to the support member, has a second arc-shaped edge for the support member to be pivoted at different angles, the base defines a through hole passing through the structural surface and the support surface, and the end of the first bracket, pivoted to the structural surface, has a first arc-shaped edge, when the bracket mechanism is in the folded state, the second arc-shaped edge overlaps with the first arc-shaped edge and fits on an edge of the through hole for the support member to be placed in the through hole.

9. The foldable stand as claimed in claim 1, wherein the support member has a magnetic element that can be magnetically attracted to a connecting member made of a metal material, and the connecting member is attached to a supported object, allowing the supported object to rotate about the support member.

10. The foldable stand as claimed in claim 1, wherein the support member is mounted on the supported object, and the support member is detachably pivoted to the second bracket.
